(19) United States
(12) Patent Application Publication
(10) Pub. No.: US 2016/0300254 A1
(43) Pub. Date: Oct. 13, 2016

(54) SYSTEM AND METHOD FOR CHARGING AND COMPENSATING USERS FOR COMMUNICATIONS BETWEEN THE USERS

(71) Applicant: Platphorm, LLC, San Francisco, CA (US)

(72) Inventors: Sean D. Van der Linden, Berkeley, CA (US); Anuj Agarwal, San Francisco, CA (US)

(73) Assignee: Platphorm, LLC, San Francisco, CA (US)

(21) Appl. No.: 14/685,503

(22) Filed: Apr. 13, 2015

(51) Int. Cl. G06Q 30/02; G06Q 50/00; H04L 12/58

(52) U.S. Cl. CPC G06Q 30/0214; H04L 51/32; G06Q 50/01; G06Q 30/0215

(57) ABSTRACT

A registration module registers a first account for the first user and a second account for a second user. A communication module provides a first interface for the first user to generate a challenge message and submit the challenge message, and a second interface for the second user at the second computer system to receive the challenge message, to generate a response message in response to the challenging message, and to submit the response message for viewing on the first interface. A billing module creates a binding between the response message and the challenge message if the challenge message is the last challenge message before the response message and the response message is the first response message after the challenge message. A compensation module transfers compensation from the first account to the second account due to the binding.

### BACKGROUND OF THE INVENTION

1). Field of the Invention

This invention relates to a service computer system adapted for charging a first user and rewarding a second user for a communication between the first user and the second user, and to a method of charging a first user and reward a second user for a communication between the first user and the second user.

2). Discussion of Related Art

Messaging, by way of text messaging, instant messaging or chat is becoming an increasingly dominant form of communication between users of computer systems and mobile phones. Messaging has also become an increasingly popular way for an expert to provide advice to a user. The user typically submits one or more questions (or other challenge messages) and the expert provides one or more answers (response messages).

An expert will be incentivized to provide an answer if they can be compensated or otherwise be rewarded for their time and effort. Subscription, flat fees and advertising are three popular ways to generate revenue that can be passed on to the expert.

These compensation methods do not fully satisfy the desire for both customers and businesses to pay and receive payment for the true value delivered. In a subscription or flat fee model, for example, light and moderate users are always supplementing for the consumption habits of the heaviest users. Ad-based models are even further distanced from the true value chain; there is very little correlation between ad revenue and the cost of a customer's consumption or the value they receive.

To get closer to the desired “pay for services consumed” ideal, payment should be more directly linked to the messages themselves. Historically, this has taken three forms: pay per unit of time (e.g., $1.99/minute), pay per message, and pay per session (where a session might have a fixed time or fixed number of messages). However, each of these has notable shortcomings. Each payment model steers those that are paying to unnatural interactions with the person (or people, or more generally “the entity”) with whom they are interacting and can often motivate bad behavior by the responder.

For example, in the instance where the payer is doing so per unit of time, he or she is highly motivated to interact as quickly as possible to maximize the value received. This causes overly quick behavior, which leads to misspeaking, typographical errors, and poorly thought-out responses. It also causes anxiety for the payer as they wait impatiently for the other party to respond. The other party, who is likely to receive all or part of the payment for the exchange, is essentially being motivated not to make a quick, focused response. The more drawn-out the interaction is, the more payment they are likely to receive.

A similar clash of interests is seen in a pay-per-message model. The payer is motivated to send long, involved messages to which the recipient is motivated to respond with short, incomplete messages. Clearly, this also is not conducive to natural exchange patterns.

A pay per session model might seem an improvement, but it is susceptible to either of the above shortcomings as soon as the necessity of defining what constitutes a session is faced. If a session is defined as a unit of time (e.g., 50 minutes), we encounter the same payer time anxiety of the payer and disinclination by the recipient for speedy, concise responses as in a pay-per-time model. Similarly, if a session is defined as a fixed number of messages, we see the same issues as those of the pay-per-message model.

It is often difficult to get the session length correct, and a failure to do so leaves one party dissatisfied. For example, if an advice seeker calls an expert for advice with a problem and pays for a fixed session and the problem is solved quickly, the advice seeker may feel they overpaid. If it takes much longer than expected, the expert may feel they were under-compensated.

### SUMMARY OF THE INVENTION

The invention provides a network environment adapted for charging a first user and reward a second user for a communication between the first user and the second user, including at least one computer system including a processor, a computer-readable medium connected to the processor, a network interface device connected to the processor and a set of instruction on the computer-readable medium. A registration module is adapted to register a first account for the first user and register a second account for a second user. A first interface is provided for the first user at a first computer system to generate a challenge message and submit the challenge message to a second computer system. A second interface is provided for the second user at a second computer system to receive the challenge message, to generate a response message in response to the challenging message, and to submit the response message to the second computer system, the response message being received by the first user through the first interface. A billing module creates a binding between the response message and the challenge message if the challenge message is the last challenge message before the response message and the response message is the first response message after the challenge message, and generates a compensation event in response to and based on the first binding being created. A compensation module transfers compensation from the first account to the second account due to the registering of the compensation event.

The invention provides a method of charging a first user and rewards a second user for a communication between the first user and the second user. At least one computer system registers a first account for the first user and a second account for a second user. A first interface is provided for the first user at a first computer system to generate a challenge message and submit the challenge message to a second computer system. A second interface is provided for the second user at a second computer system to receive the challenge message, to generate a response message in response to the challenging message, and to submit the response message to the second computer system, the response message being received by the first user through the first interface. A binding is created by the at least one computer system between the response message and the challenge message if the challenge message is the last challenge message before the response message and the response message is the first response message after the challenge message. A compensation event is generated by the at least one computer system in response to and based on the first binding being created. The at least one computer system transfers compensation from the first account to the second account due to the registering of the compensation event.

The invention further provides a service computer system adapted for charging a first user and reward a second user for a communication between the first user and the second user, including a processor, a computer-readable medium connected to the processor, a network interface device connected to the processor, a set of instructions on the computer-readable medium. A registration module is adapted to register a first account for the first user and register a second account for a second user. A first computer system of the first user is connected to a second computer system of the second user. A first user through a first interface at the first computer system generates a challenge message of at least a first exchange and submits the challenge message of the first exchange to the second computer system. A second user through a second interface at the second computer system receives the challenge message of the first exchange, generates a first response message of the first exchange in response to the challenging message of the first exchange, and to submit the first response message of the first exchange to the second computer system. The first response message of the first exchange is received by the first user through the first interface. A first binding is created between the first response message of the first exchange and the challenge message of the first exchange if the challenge message of the first exchange is the last challenge message of the first exchange before the first response message of the first exchange and the first response message of the first exchange is the first response message of the first exchange after the challenge message of the first exchange. A billing module is adapted to generate a first compensation event in response to and based on the first binding being created. A compensation module is adapted to transfer compensation from the first account to the second account due to the registering of the first compensation event.

The first user through the first interface at the first computer system may generate a plurality of challenge messages of at least the first exchange and submit the plurality of challenge messages of the first exchange to the second computer system, the first response message of the first exchange being submitted after a last challenge message of the first exchange, being a challenge message that is last in time of the plurality of challenge messages of the first exchange, and the first binding being created between the first response message of the first exchange and the last challenge message of the first exchange.

The first user through the first interface at the first computer system may generate first, second and third challenge messages of at least the first exchange and submit the first, second and third challenge messages of the first exchange to the second computer system, the first response message of the first exchange being submitted after the third challenge message of the first exchange and the first binding being created between the first response message of the first exchange and the third challenge message of the first exchange.

The first user through the first interface at the first computer system may generate a challenge message of at least a second exchange and submit the challenge message of the second exchange to the second computer system. The second user through the second interface at the second computer system may receive the challenge message of the second exchange, generate a first response message of the second exchange in response to the challenging message of the second exchange, and submit the first response message of the second exchange to the second computer system, the first response message of the second exchange being received by the first user through the first interface. A second binding may be created between the first response message of the second exchange and the challenge message of the second exchange if the challenge message of the second exchange is the last challenge message of the second exchange before the first response message of the second exchange and the first response message of the second exchange is the first response message of the second exchange after the challenge message of the second exchange. The billing module may be adapted to generate a second compensation event in response to and based on the second binding being created. The compensation module may be adapted to transfer compensation from the first account to the second account due to the registering of the second compensation event.

The first user through the first interface at the first computer system may generate first and second challenge messages of at least the second exchange and submit the first and second challenge messages of the second exchange to the second computer system, the first response message of the second exchange being submitted after the second challenge message of the second exchange and the second binding being created between the first response message of the second exchange and the second challenge message of the second exchange.

The second user through the second interface at the second computer system may generate a second response message of the first exchange after the first response message of the first exchange, and submit the second response message of the first exchange to the second computer system, the second response message of the first exchange being received by the first user through the first interface.

The service computer system may include a communication module adapted to utilize the network interface device to connect a first computer system of the first user to a second computer system of the second user.

The communication module may be adapted to provide a first interface for the first user at the first computer system to generate a challenge message of the first exchange and submit the challenge message of the first exchange to the second computer system, and to provide a second interface for the second user at the second computer system to receive the challenge message of the first exchange, to generate a first response message of the first exchange in response to the challenging message of the first exchange, and to submit the first response message of the first exchange to the second computer system, the first response message of the first exchange being received by the first user through the first interface.

The billing module may be adapted to record the challenge message of the first exchange and the first response message of the first exchange and to create a first binding between the first response message of the first exchange and the challenge message of the first exchange if the challenge message of the first exchange is the last challenge message of the first exchange before the first response message of the first exchange and the first response message of the first exchange is the first response message of the first exchange after the challenge message of the first exchange.

The first interface and the second interface may be provided to the first and second users, respectively, through a website that is hosted by the service computer system.

The first interface and the second interface may be provided to the first and second users, respectively, through an app that is distributed to the first and second computer systems, the first and second computer systems being mobile devices.

The service computer system may include a money exchange module adapted to transfer funds into the first account before the first exchange and transfer funds out of the second account after the first exchange.

The invention provides a method of charging a first user and reward a second user for a communication between the first user and the second user. A service computer system may register a first account for the first user and a second account for a second user. A first computer system of the first user may be connected to a second computer system of the second user. A first user through a first interface at the first computer system may generate a challenge message of at least a first exchange and submit the challenge message of the first exchange to the second computer system. A second user through a second interface at the second computer system may receive the challenge message of the first exchange, generate a first response message of the first exchange in response to the challenging message of the first exchange, and submit the first response message of the first exchange to the second computer system, the first response message of the first exchange being received by the first user through the first interface. A first binding may be created between the first response message of the first exchange and the challenge message of the first exchange if the challenge message of the first exchange is the last challenge message of the first exchange before the first response message of the first exchange and the first response message of the first exchange is the first response message of the first exchange after the challenge message of the first exchange. The service computer system may generate a first compensation event in response to and based on the first binding being created. The service computer system may transfer compensation from the first account to the second account due to the registering of the first compensation event.

The method may include that the first user through the first interface at the first computer system generate a plurality of challenge messages of at least the first exchange and submit the plurality of challenge messages of the first exchange to the second computer system, the first response message of the first exchange being submitted after a last challenge message of the first exchange, being a challenge message that is last in time of the plurality of challenge messages of the first exchange, and the first binding being created between the first response message of the first exchange and the last challenge message of the first exchange.

The method may include that the first user through the first interface at the first computer system to generate first, second and third challenge messages of at least the first exchange and submit the first, second and third challenge messages of the first exchange to the second computer system, the first response message of the first exchange being submitted after the third challenge message of the first exchange and the first binding being created between the first response message of the first exchange and the third challenge message of the first exchange.

The method may include that the first user through the first interface at the first computer system to generate a challenge message of at least a second exchange and submit the challenge message of the second exchange to the second computer system, the second user through the second interface at the second computer system to receive the challenge message of the second exchange, to generate a first response message of the second exchange in response to the challenging message of the second exchange, and to submit the first response message of the second exchange to the second computer system, the first response message of the second exchange being received by the first user through the first interface, a second binding being created between the first response message of the second exchange and the challenge message of the second exchange if the challenge message of the second exchange is the last challenge message of the second exchange before the first response message of the second exchange and the first response message of the second exchange is the first response message of the second exchange after the challenge message of the second exchange, further including generating, by the service computer system, a second compensation event in response to and based on the second binding being created and transferring, by the service computer system, compensation from the first account to the second account due to the registering of the second compensation event.

The method may include that the first user through the first interface at the first computer system generate first and second challenge messages of at least the second exchange and submit the first and second challenge messages of the second exchange to the second computer system, the first response message of the second exchange being submitted after the second challenge message of the second exchange and the second binding being created between the first response message of the second exchange and the second challenge message of the second exchange.

The method may include that the second user through the second interface at the second computer system generate a second response message of the first exchange after the first response message of the first exchange, and submit the second response message of the first exchange to the second computer system, the second response message of the first exchange being received by the first user through the first interface.

The method may include connecting, by the service computer system, a first computer system of the first user to a second computer system of the second user.

The method may include providing, by the service computer system, a first interface for the first user at the first computer system to generate a challenge message of the first exchange and submit the challenge message of the first exchange to the second computer system and providing, by the service computer system, a second interface for the second user at the second computer system to receive the challenge message of the first exchange, to generate a first response message of the first exchange in response to the challenging message of the first exchange, and to submit the first response message of the first exchange to the second computer system, the first response message of the first exchange being received by the first user through the first interface.

The method may include recording, by the service computer system, the challenge message of the first exchange and the first response message of the first exchange and creating, by the service computer system, a first binding between the first response message of the first exchange and the challenge message of the first exchange if the challenge message of the first exchange is the last challenge message of the first exchange before the first response message of the first exchange and the first response message of the first exchange is the first response message of the first exchange after the challenge message of the first exchange.

The method may include that the first interface and the second interface are provided to the first and second users, respectively, through a website that is hosted by the service computer system.

The method may include that the first interface and the second interface are provided to the first and second users, respectively, through an app that is distributed to the first and second computer systems, the first and second computer systems being mobile devices.

The method may include transferring, by the service computer system, funds into the first account before the first exchange and transferring, by the service computer system, funds out of the second account after the first exchange.

### BRIEF DESCRIPTION OF THE DRAWINGS

The invention is further described by way of examples with reference to the accompanying drawings, wherein:

FIG. 1 is a block diagram of a network environment having a service computer system and first and second computer systems according to an embodiment of the invention;

FIG. 2 is a screen shot of the first computer system displaying a first interface for selection of an expert;

FIG. 3 is a screen shot of the second computer system displaying a second interface for accepting a communication request;

FIG. 4 is a block diagram illustrating how messages are communicated between the first and second computer systems using first and second interfaces provided through a website of the service computer system;

FIG. 5 is a data structure illustrating how compensation events are created due to the exchange of messages between the first and second computer systems;

FIG. 6 is a block diagram illustrating how funds are transferred from a first account to a second account due to the compensation events;

FIG. 7 is block diagram illustrating how messages are communicated between first and second mobile devices that run respective apps and the messages are communicated through the service computer system;

FIG. 8 is a block diagram according to a further embodiment of the invention wherein a communication module of the service computer system creates a peer-to-peer connection and messages are communicated directly between first and second mobile devices; and

FIG. 9 is a block diagram of a machine in the form of a computer system forming part of the network environment.

### DETAILED DESCRIPTION OF THE INVENTION

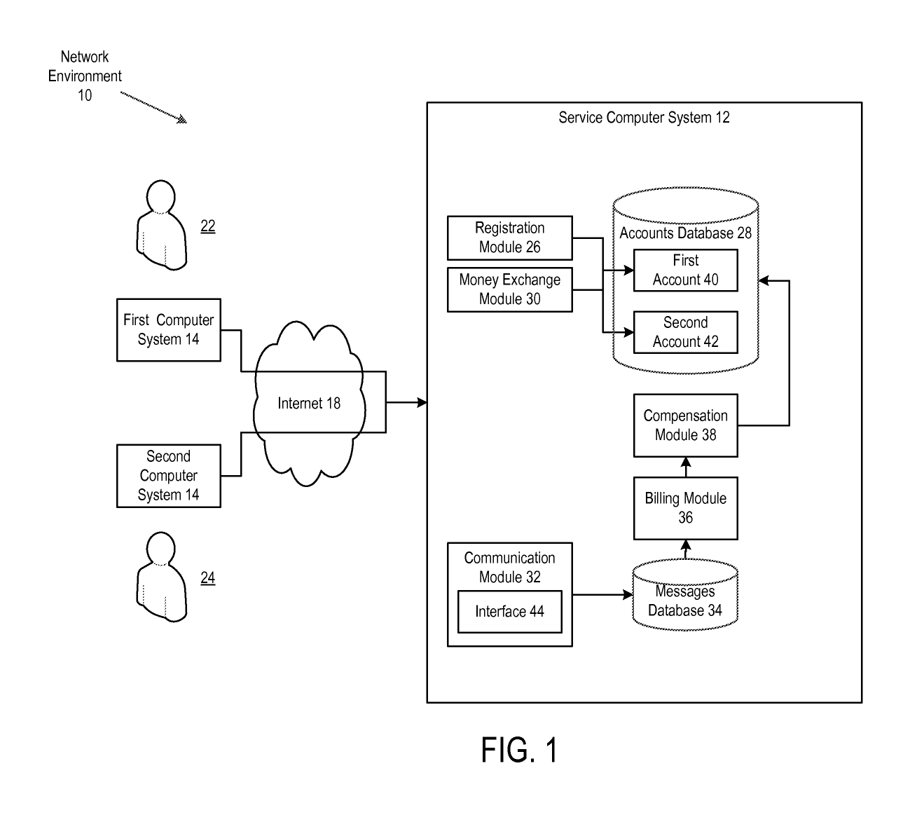

FIG. 1 of the accompanying drawings illustrates a network system 10, according to an embodiment of the invention, including a service computer system 12 and first and second computer systems 14 and 16 connected to the service computer system 12 over the Internet 18. A first user 22 is located at the first computer system 14 and a second user 24 is located at the second computer system 16. The service computer system 12 is adapted for charging the first user 22 and reward the second user 24 for a communication between the first user 22 and the second user 24.

The service computer system 12 includes a registration module 26, an accounts database 28, a money exchange module 30, a communication module 32, a messages database 34, a billing module 36 and a compensation module 38.

The first user 22 uses the first computer system 14 to access the registration module 26 over the Internet 18. The first user 22 uses the registration module 26 to create a first account 40 for the first user 22. Similarly, the second user 24 uses the second computer system 16 to access the registration module 26 over the Internet 18 and creates a second account 42 for the second user 24. The first and second accounts 40 and 42 are held within the accounts database 28. Each account 40 or 42 includes login details such as a username and password and a communication identifier (ID) for the respective user 22 or 24. Each account 40 or 42 also includes a credit value representing funds that are available within the respective account 40 or 42.

The first user 22 uses the first computer system 14 to access the money exchange module 30 over the Internet 18. The first user 22 can then utilize the money exchange module 30 to transfer funds from another source such as their bank account and have the transfer be reflected within the credit value of the first account 40. The service computer system 12 then permits first user 22 to engage in communications that are charged against the credit value in the first account 40.

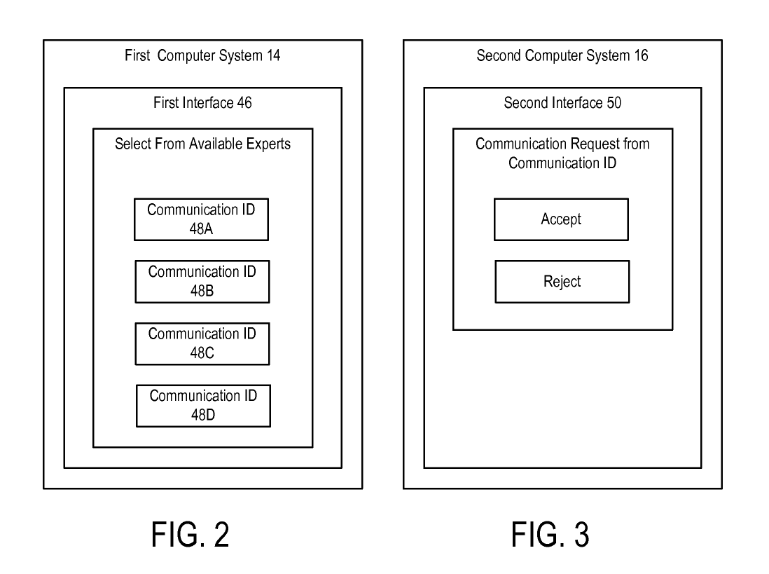

The communication module 32 includes a website having an interface 44. The user at the first computer system 14 accesses the communication module 32 over the Internet 18 and downloads the interface 44 onto the first computer system 14 as a first interface. FIG. 2 shows a first interface 46 that is presented on a display of the first computer system 14. The second account 42 in FIG. 1 represents an account of an expert with one communication ID. Multiple accounts of multiple experts may be registered with the accounts database 28. As shown in FIG. 2, the first user 22 at the first computer system 14 in FIG. 1 is presented with a plurality of communication IDs 48A to 48D, each representing a respective expert. The first user 22 can then select one of the communication IDs 48A to 48D to initiate communication with one of the experts. The respective expert can then be notified of the request from the first user 22 using conventional communication tools such as email, messaging or instant messaging. In the present example, it will be assumed that the first user 22 has selected the communication ID of the second account 42 corresponding to the second user 24 at the second computer system 16 in FIG. 1.

The second user 24 uses the second computer system 16 to connect to the communication module 32 over the Internet 18. The second computer system 16 then downloads the interface 44 onto the second computer system 16 as a second interface. FIG. 3 shows a second interface 50 that is presented on a display of the second computer system 16. The second user 24 can then select to accept or reject the communication request from the first user 22 at the first computer system 14 by either selecting an “Accept” button or “Reject” button. If the second user 24 accepts the communication, the communication module 32 connects the first and second computer systems 14 and 16 to one another for purposes of initiating a chat communication.

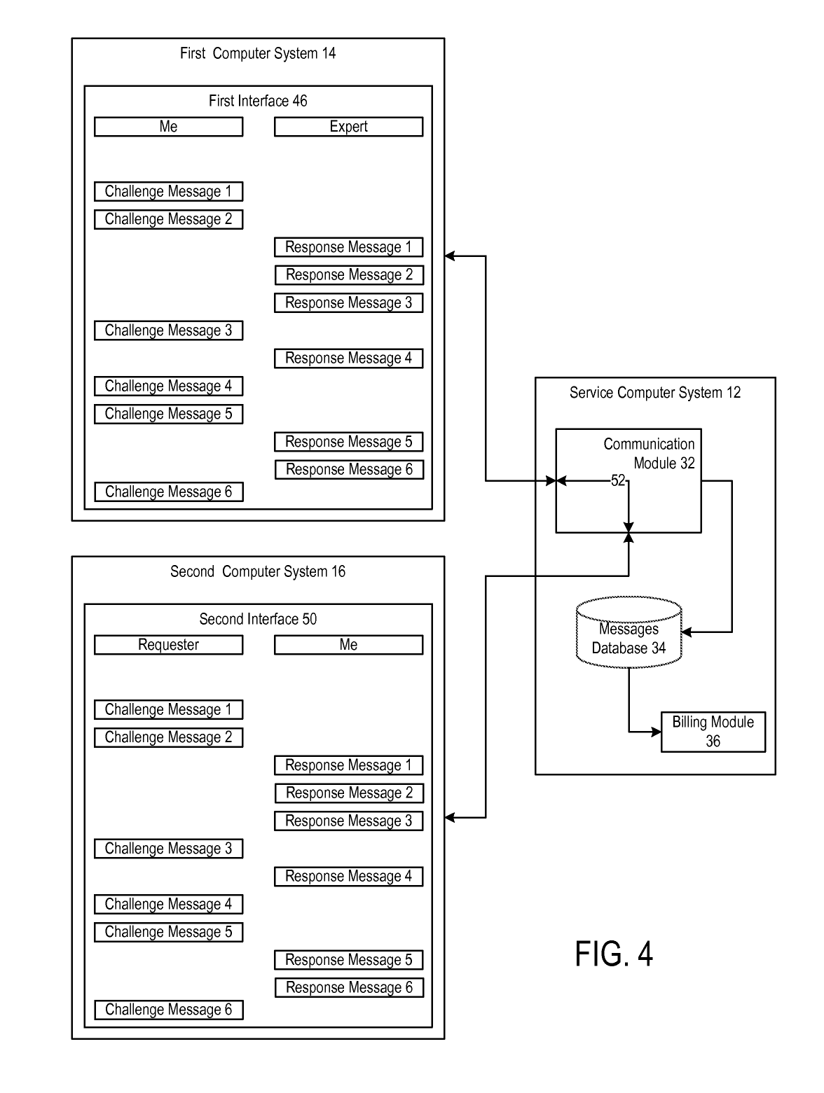

FIG. 4 shows a chat session that is initiated between the first and second computer systems 14 and 16. The communication path 52 represents a connection between the first and second computer systems 14 and 16 that is established by the communication module 32 and passes through communication module 32. All messages between the first and second computer systems 14 and 16, including the text content of the messages, also pass through the communication module 32. The communication module 32 creates a timestamp for each message and records the messages in chronological order within the messages database 34.

The first user 22 at the first computer system 14 generates first and second challenge messages (Challenge Message 1 and Challenge Message 2). The first and second challenge messages are then displayed within the first interface 46, submitted through the communication module 32 to the second computer system 16, and displayed within the second interface 50 to the second user 24 at the second computer system 16. The second user 24 then generates first, second and third response messages (Response Message 1, Response Message 2 and Response Message 3). The first, second and third response messages are displayed within the second interface 50 to the second user 24, are submitted through the communication module 32 to the first computer system 14 and are displayed within the first interface 46. In a similar manner, the first user 22 then creates a third challenge message (Challenge Message 3) and the second user 24 creates a fourth response message (Response Message 4). The message continue until, in the present example, the first user 22 has created six challenge messages and the second user 24 has created six response messages that are listed in chronological order from top to bottom within both interfaces 46 and 50. In this manner, the first and second users 22 and 24 can generate and submit messages to one another and the messages are received by the other user.

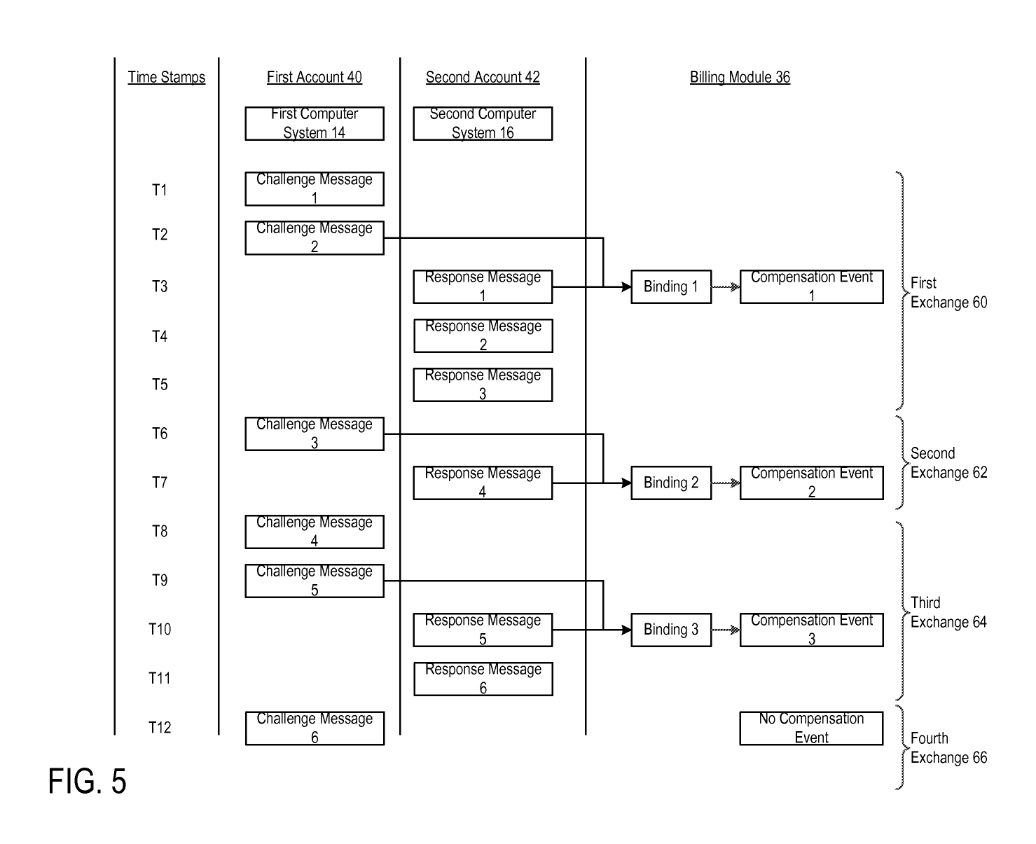

FIG. 5 illustrates the data structure within the messages database 34 in FIG. 4 in more detail. The challenge and response messages are associated with the first and second accounts 40 and 42, respectively, and are ordered in chronologically from time T1 to T12.

The first challenge message starts a first exchange 60 at T1. No compensation event occurs at T1. T2 represents the last challenge message that is submitted by the first computer system 14 before a response is submitted by the second computer system 16. No compensation event occurs at T2.

The first response message at T3 is the response message directly after the last challenge message at T2. Because the first response message at T3 directly follows the last challenge message at T2, the billing module 36 creates a first binding (Binding 1) between the second challenge message and the first response message. A first compensation event (Compensation Event 1) is created due to the first binding. The first binding and the first compensation event occur at T3.

The second response message and third response message submitted at T4 and T5 form part of the first exchange 60. No compensation event occurs due to the second or third response messages.

The third challenge message that is submitted at T6 terminates the first exchange 60 and starts a second exchange 62. The fourth response message submitted at T7 is the response message directly after the last challenge message at T6 within the second exchange 62. A second binding (Binding 2) is created between the third challenge message submitted at T6 and the fourth response message submitted at T7. A second compensation event (Compensation Event 2) is created due to the second binding. The first exchange 60 thus includes only a single compensation event, namely the Compensation Event 1 and the second exchange 62 includes only a single compensation event, namely the Compensation Event 2.

The fourth challenge message submitted T8 terminates the second exchange 62 and starts a third exchange 64. No compensation event is created due to the fourth challenge message submitted at T8 or the fifth challenge message submitted T9. Because the fifth response message submitted at T10 is the response message directly after the last challenge message submitted at T9, the billing module 36 creates a third binding (Binding 3). The billing module 36 also creates a third compensation event (Compensation Event 3) due to the third binding. The sixth response message submitted at T11 forms part of the third exchange 64. No compensation event is created due to the sixth response message.

The sixth challenge message (Challenge Message 6) submitted at T12 terminates the third exchange 64 and starts a fourth exchange 66 because no response has been received with the fourth exchange 66, no compensation event occurs until such a response has been received.

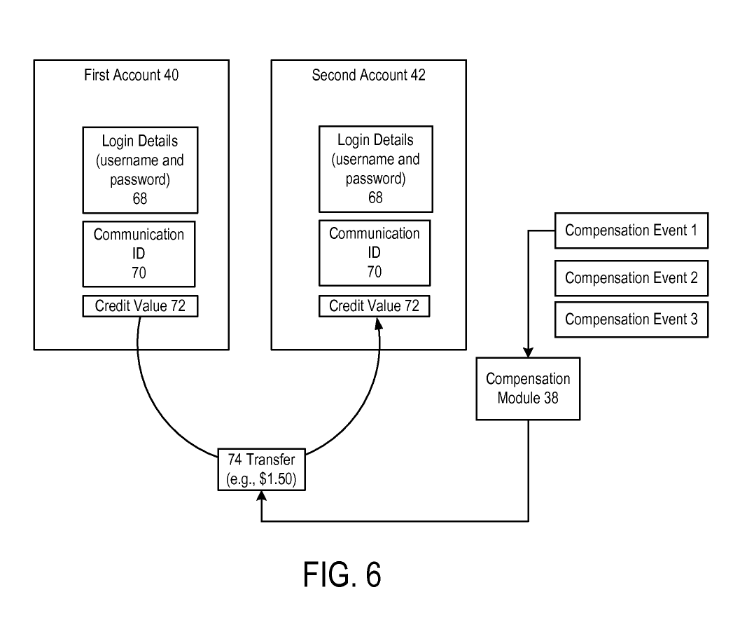

As shown in FIG. 6, and as mentioned previously, each account 40 or 42 includes respective login details 68, a communication ID 70 and a credit value 72. Due to the first compensation event, the compensation module 38, at 74, creates a transfer from the credit value 72 in the first account 40 to the credit value 72 in the second account 42. A respective compensation event may for example result in a transfer of a fixed amount of, for example $1.50, so that the credit value 72 within the first account 40 is reduced by $1.50 and the credit value 72 in the second account 42 is increased by a $1.50.

Due to the second compensation event, the compensation module 38 makes a further transfer from the credit value 72 in the first account 40 to the credit value 72 in the second account 42. The second transfer may also be for a $1.50. Due to the third compensation event, the compensation module 38 makes a further transfer of $1.50 from the credit value 72 in the first account 40 to the credit value 72 in the second account 42. The first, second and third compensation events are the only compensation events that result in any transfers between the accounts 40 and 42.

The user of the second account 42 can use the money exchange module 30 in FIG. 1 to transfer funds out of the second account 42 to their bank account or any other stored value account. The credit value 72 is reduced by the amount transferred out by the second user 24.

The present invention describes a method and apparatus for solving the problems associated with traditional models for monetizing chat. Chat sessions are monetized in a manner that is tied to the value delivered, unlike subscriptions, flat fees, or advertising models, but does not have the adverse behavioral impacts of pay-per-time/message/session models.

Compensation is directly tied to the actual exchange of information between a payer and a provider. However, rather than using time, message, or session as the billable denominator, the current method is based on a unit of interaction referred to as an “exchange”. The first user is charged and the second user earns all or a portion of the payment based on the occurrence of an exchange.

An exchange only occurs if the second user makes his/her first response to the first user's last message. This means the first user can send any number of messages and will not be charged until the second user responds. This reduces anxiety that time is of the essence or that the payer will be charged for a message that may never receive a response.

Further, since an exchange considers only the provider's first response to the last message sent by the payer, there is no fear of paying for the return of many short responses by the provider, as there would be in a pay-per-message model. Additionally, the provider is motivated to make timely and useful responses because they are only compensated when they respond to the payer's last message.

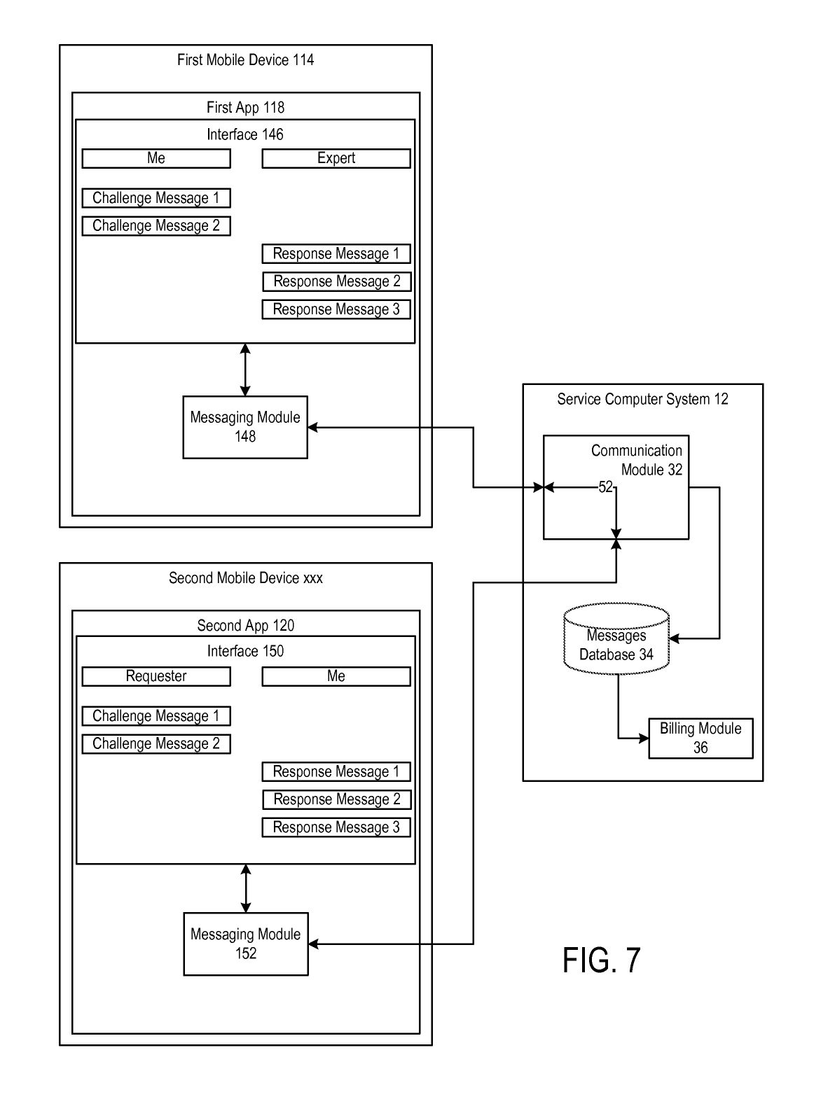

In the example illustrated in FIG. 4, the first and second interfaces 46 and 50 are provided to the first and second users 22 and 24, respectively, through a website that is hosted by the service computer system 12. FIG. 7 illustrates an alternate embodiment wherein the first and second computer systems 14 and 16 of FIG. 4 are first and second mobile devices 114 and 116. The first mobile device 114 has a first app 118 and the second mobile device 116 has a second app 120. The first app 118 has an interface 146 and a messaging module 148. The second app 120 has an interface 150 and a messaging module 152. The messaging modules 148 and 152 communicate messages between one another through the communication module 32 of the service computer system 12. The interfaces 146 and 150 display the messages to the first and second users 22 and 24. The service computer system 12 may for example distribute the first and second apps 118 and 120 to the first and second mobile devices 114 and 116 through an app store.

In the embodiments of FIGS. 4 and 7, all messages are communicated through the communication module 32 and are recorded within the messages database 34 for analysis by the billing module 36.

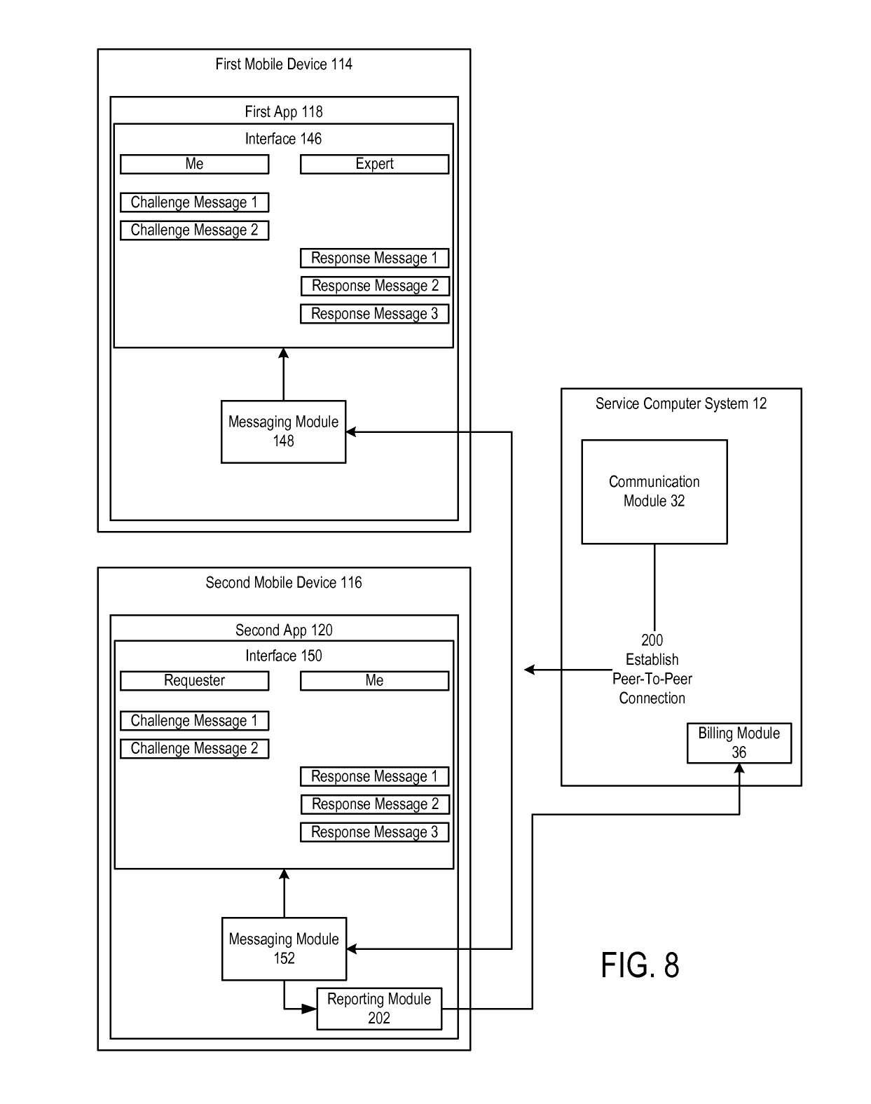

FIG. 8 illustrates an alternate embodiment where the messages are not communicated through the service computer system 12 or the communication module 32 of the service computer system 12. The communication module 32 may, at 200, establish a Peer-to-Peer connection between the messaging modules 148 and 152. The messaging modules 148 and 152 may then communicate directly with one another without transmitting the messages through the service computer system 12. The second app 120 has a reporting module 202 connected to the messaging module 152. The reporting module 202 records at least a first response to a challenge message submitted by the second mobile device 116, but may also record all challenge messages and response messages with their respective timestamps. The reporting module 202 then submits the data that is recorded to the billing module 36. The billing module 36 is thus informed when a binding occurs between a challenge message and a response message as described with reference to FIG. 5. The billing module 36 then creates compensation events as described with reference to FIG. 5.

An additional embodiment can establish a time window in which a provider must respond to a payer's message for an exchange to be charged. This further motivates a provider to make timely responses and provides additional peace of mind to the payer.

A payer may be given credit or promotions such that actual payment is not required to participate in an exchange-based paid chat.

The invention is not limited to questions that are asked by a first user and answers that are provided by an expert. In an entertainment embodiment, the second user can be a comedian that provides jokes as responsive message to the first user. The first user may be a person seeking therapy and the second user may be a person providing therapy and the exchange between them may be more of a discussion than a question and answer session.

The invention has been described by way of example wherein an interface is a visual interface presented of a computer system or mobile device. It should however be understood that an interface is not limited to a visual interface and may for example be a voice interface, a tactile interface or the like.

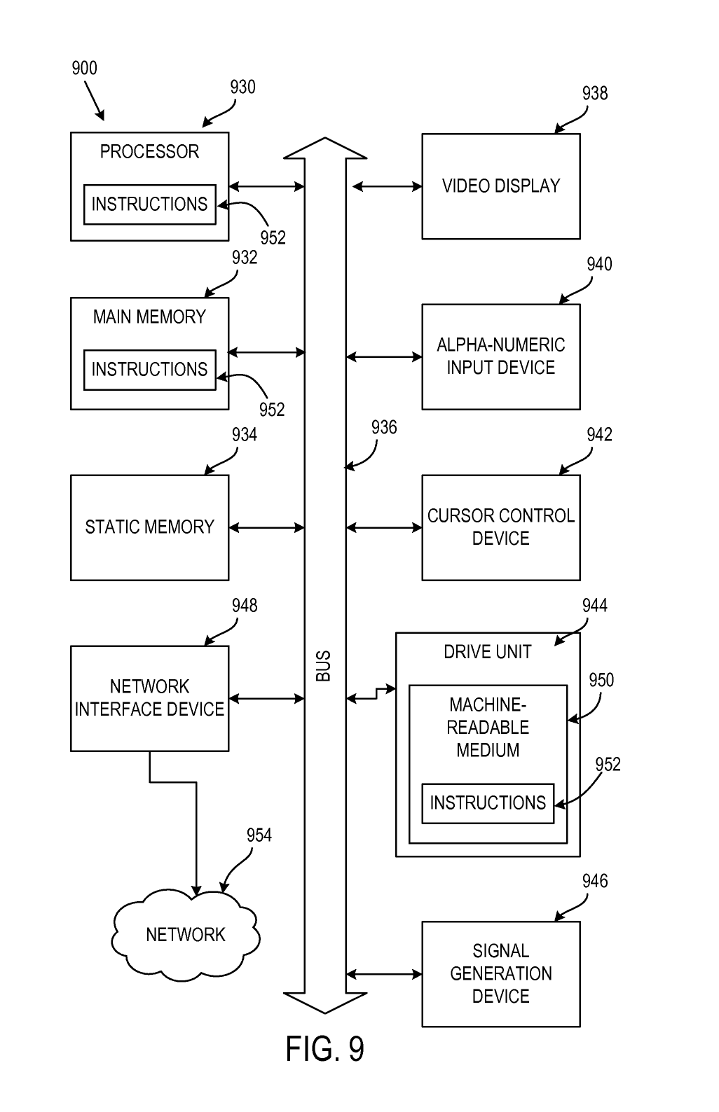

FIG. 9 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 930 (e.g., a central processing unit (CPU), a graphics processing unit (GPU), or both), a main memory 932 (e.g., read-only memory (ROM), flash memory, dynamic random access memory (DRAM) such as synchronous DRAM (SDRAM) or Rambus DRAM (RDRAM), etc.), and a static memory 934 (e.g., flash memory, static random access memory (SRAM, etc.), which communicate with each other via a bus 936.

The computer system 900 may further include a video display 938 (e.g., a liquid crystal displays (LCD) or a cathode ray tube (CRT)). The computer system 900 also includes an alpha-numeric input device 940 (e.g., a keyboard), a cursor control device 942 (e.g., a mouse), a disk drive unit 944, a signal generation device 946 (e.g., a speaker), and a network interface device 948.

The disk drive unit 944 includes a machine-readable medium 950 on which is stored one or more sets of instructions 952 (e.g., software) embodying any one or more of the methodologies or functions described herein. The software may also reside, completely or at least partially, within the main memory 932 and/or within the processor 930 during execution thereof by the computer system 900, the memory 932 and the processor 930 also constituting machine readable media. The software may further be transmitted or received over a network 954 via the network interface device 948.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A network environment adapted for charging a first user and reward a second user for a communication between the first user and the second user, comprising:
at least one computer system comprising:
a processor;
a computer-readable medium connected to the processor;
a network interface device connected to the processor;
a set of instruction on the computer-readable medium, including:
a registration module adapted to register a first account for the first user and register a second account for a second user;
a first interface provided for the first user at a first computer system to generate a challenge message and submit the challenge message to a second computer system;
a second interface provided for the second user at a second computer system to receive the challenge message, to generate a response message in response to the challenging message, and to submit the response message to the second computer system, the response message being received by the first user through the first interface;
a billing module creating a binding between the response message and the challenge message if the challenge message is the last challenge message before the response message and the response message is the first response message after the challenge message, and generating a compensation event in response to and based on the first binding being created; and
a compensation module transferring compensation from the first account to the second account due to the registering of the compensation event.

2. A method of charging a first user and reward a second user for a communication between the first user and the second user, comprising:
registering, by at least one computer system, a first account for the first user;
registering, by the at least one computer system, a second account for a second user, providing a first interface for the first user at a first computer system to generate a challenge message and submit the challenge message to a second computer system;
providing a second interface for the second user at a second computer system to receive the challenge message, to generate a response message in response to the challenging message, and to submit the response message to the second computer system, the response message being received by the first user through the first interface;
creating, by at least one computer system, a binding between the response message and the challenge message if the challenge message is the last challenge message before the response message and the response message is the first response message after the challenge message;
generating, by the at least one computer system, a compensation event in response to and based on the first binding being created; and
transferring, by the at least one computer system, compensation from the first account to the second account due to the registering of the compensation event.

3. A service computer system adapted for charging a first user and reward a second user for a communication between the first user and the second user, comprising:
a processor;
a computer-readable medium connected to the processor;
a network interface device connected to the processor;
a set of instructions on the computer-readable medium, including:
a registration module adapted to register a first account for the first user and register a second account for a second user, a first computer system of the first user to be connected to a second computer system of the second user, a first user through a first interface at the first computer system to generate a challenge message of at least a first exchange and submit the challenge message of the first exchange to the second computer system, a second user through a second interface at the second computer system to receive the challenge message of the first exchange, to generate a first response message of the first exchange in response to the challenging message of the first exchange, and to submit the first response message of the first exchange to the second computer system, the first response message of the first exchange being received by the first user through the first interface, a first binding being created between the first response message of the first exchange and the challenge message of the first exchange if the challenge message of the first exchange is the last challenge message of the first exchange before the first response message of the first exchange and the first response message of the first exchange is the first response message of the first exchange after the challenge message of the first exchange, a billing module adapted to generate a first compensation event in response to and based on the first binding being created; and
a compensation module adapted to transfer compensation from the first account to the second account due to the registering of the first compensation event.

4. The service computer system of claim 3, the first user through the first interface at the first computer system to generate a plurality of challenge messages of at least the first exchange and submit the plurality of challenge messages of the first exchange to the second computer system, the first response message of the first exchange being submitted after a last challenge message of the first exchange, being a challenge message that is last in time of the plurality of challenge messages of the first exchange, and the first binding being created between the first response message of the first exchange and the last challenge message of the first exchange.

5. The service computer system of claim 4, the first user through the first interface at the first computer system to generate first, second and third challenge messages of at least the first exchange and submit the first, second and third challenge messages of the first exchange to the second computer system, the first response message of the first exchange being submitted after the third challenge message of the first exchange and the first binding being created between the first response message of the first exchange and the third challenge message of the first exchange.

6. The service computer system of claim 4, the first user through the first interface at the first computer system to generate a challenge message of at least a second exchange and submit the challenge message of the second exchange to the second computer system, the second user through the second interface at the second computer system to receive the challenge message of the second exchange, to generate a first response message of the second exchange in response to the challenging message of the second exchange, and to submit the first response message of the second exchange to the second computer system, the first response message of the second exchange being received by the first user through the first interface, a second binding being created between the first response message of the second exchange and the challenge message of the second exchange if the challenge message of the second exchange is the last challenge message of the second exchange before the first response message of the second exchange and the first response message of the second exchange is the first response message of the second exchange after the challenge message of the second exchange, the billing module adapted to generate a second compensation event in response to and based on the second binding being created, and the compensation module adapted to transfer compensation from the first account to the second account due to the registering of the second compensation event.

7. The service computer system of claim 6, the first user through the first interface at the first computer system to generate first and second challenge messages of at least the second exchange and submit the first and second challenge messages of the second exchange to the second computer system, the first response message of the second exchange being submitted after the second challenge message of the second exchange and the second binding being created between the first response message of the second exchange and the second challenge message of the second exchange.

8. The service computer system of claim 3, the second user through the second interface at the second computer system to generate a second response message of the first exchange after the first response message of the first exchange, and to submit the second response message of the first exchange to the second computer system, the second response message of the first exchange being received by the first user through the first interface.

9. The service computer system of claim 3, further comprising:
a communication module adapted to utilize the network interface device to connect a first computer system of the first user to a second computer system of the second user.

10. The service computer system of claim 9, the communication module adapted to provide a first interface for the first user at the first computer system to generate a challenge message of the first exchange and submit the challenge message of the first exchange to the second computer system, and to provide a second interface for the second user at the second computer system to receive the challenge message of the first exchange, to generate a first response message of the first exchange in response to the challenging message of the first exchange, and to submit the first response message of the first exchange to the second computer system, the first response message of the first exchange being received by the first user through the first interface.

11. The service computer system of claim 9, further comprising:
the billing module adapted to record the challenge message of the first exchange and the first response message of the first exchange and to create a first binding between the first response message of the first exchange and the challenge message of the first exchange if the challenge message of the first exchange is the last challenge message of the first exchange before the first response message of the first exchange and the first response message of the first exchange is the first response message of the first exchange after the challenge message of the first exchange.

12. The service computer system of claim 10, wherein the first interface and the second interface are provided to the first and second users, respectively, through a website that is hosted by the service computer system.

13. The service computer system of claim 10, wherein the first interface and the second interface are provided to the first and second users, respectively, through an app that is distributed to the first and second computer systems, the first and second computer systems being mobile devices.

14. The service computer system of claim 3, further comprising:
a money exchange module adapted to transfer funds into the first account before the first exchange; and
transfer funds out of the second account after the first exchange.

15. A method of charging a first user and reward a second user for a communication between the first user and the second user, comprising:
registering, by a service computer system, a first account for the first user;
registering, by the service computer system, a second account for a second user, a first computer system of the first user to be connected to a second computer system of the second user, a first user through a first interface at the first computer system to generate a challenge message of at least a first exchange and submit the challenge message of the first exchange to the second computer system, a second user through a second interface at the second computer system to receive the challenge message of the first exchange, to generate a first response message of the first exchange in response to the challenging message of the first exchange, and to submit the first response message of the first exchange to the second computer system, the first response message of the first exchange being received by the first user through the first interface, a first binding being created between the first response message of the first exchange and the challenge message of the first exchange if the challenge message of the first exchange is the last challenge message of the first exchange before the first response message of the first exchange and the first response message of the first exchange is the first response message of the first exchange after the challenge message of the first exchange;
generating, by the service computer system, a first compensation event in response to and based on the first binding being created; and
transferring, by the service computer system, compensation from the first account to the second account due to the registering of the first compensation event.

16. The method of claim 15, the first user through the first interface at the first computer system to generate a plurality of challenge messages of at least the first exchange and submit the plurality of challenge messages of the first exchange to the second computer system, the first response message of the first exchange being submitted after a last challenge message of the first exchange, being a challenge message that is last in time of the plurality of challenge messages of the first exchange, and the first binding being created between the first response message of the first exchange and the last challenge message of the first exchange.

17. The method of claim 16, the first user through the first interface at the first computer system to generate first, second and third challenge messages of at least the first exchange and submit the first, second and third challenge messages of the first exchange to the second computer system, the first response message of the first exchange being submitted after the third challenge message of the first exchange and the first binding being created between the first response message of the first exchange and the third challenge message of the first exchange.

18. The method of claim 16, the first user through the first interface at the first computer system to generate a challenge message of at least a second exchange and submit the challenge message of the second exchange to the second computer system, the second user through the second interface at the second computer system to receive the challenge message of the second exchange, to generate a first response message of the second exchange in response to the challenging message of the second exchange, and to submit the first response message of the second exchange to the second computer system, the first response message of the second exchange being received by the first user through the first interface, a second binding being created between the first response message of the second exchange and the challenge message of the second exchange if the challenge message of the second exchange is the last challenge message of the second exchange before the first response message of the second exchange and the first response message of the second exchange is the first response message of the second exchange after the challenge message of the second exchange, further comprising:
generating, by the service computer system, a second compensation event in response to and based on the second binding being created; and
transferring, by the service computer system, compensation from the first account to the second account due to the registering of the second compensation event.

19. The method of claim 18, the first user through the first interface at the first computer system to generate first and second challenge messages of at least the second exchange and submit the first and second challenge messages of the second exchange to the second computer system, the first response message of the second exchange being submitted after the second challenge message of the second exchange and the second binding being created between the first response message of the second exchange and the second challenge message of the second exchange.

20. The method of claim 15, the second user through the second interface at the second computer system to generate a second response message of the first exchange after the first response message of the first exchange, and to submit the second response message of the first exchange to the second computer system, the second response message of the first exchange being received by the first user through the first interface.

21. The method of claim 15, further comprising:
connecting, by the service computer system, a first computer system of the first user to a second computer system of the second user.

22. The method of claim 21, further comprising:
providing, by the service computer system, a first interface for the first user at the first computer system to generate a challenge message of the first exchange and submit the challenge message of the first exchange to the second computer system; and
providing, by the service computer system, a second interface for the second user at the second computer system to receive the challenge message of the first exchange, to generate a first response message of the first exchange in response to the challenging message of the first exchange, and to submit the first response message of the first exchange to the second computer system, the first response message of the first exchange being received by the first user through the first interface.

23. The method of claim 21, further comprising:
recording, by the service computer system, the challenge message of the first exchange and the first response message of the first exchange; and
creating, by the service computer system, a first binding between the first response message of the first exchange and the challenge message of the first exchange if the challenge message of the first exchange is the last challenge message of the first exchange before the first response message of the first exchange and the first response message of the first exchange is the first response message of the first exchange after the challenge message of the first exchange.

24. The method of claim 22, wherein the first interface and the second interface are provided to the first and second users, respectively, through a website that is hosted by the service computer system.

25. The method of claim 22, wherein the first interface and the second interface are provided to the first and second users, respectively, through an app that is distributed to the first and second computer systems, the first and second computer systems being mobile devices.

26. The method of claim 15, further comprising:
transferring, by the service computer system, funds into the first account before the first exchange; and
transferring, by the service computer system, funds out of the second account after the first exchange.
